(19) United States
(12) Patent Application Publication
(10) Pub. No.: US 2026/0228081 A1
(43) Pub. Date: Aug. 6, 2026

(54) PROACTIVE DISASTER RECOVERY OF A DEPLOYMENT

(71) Applicant: Dell Products L.P., Round Rock, TX (US)

(72) Inventors: GOVINDASAMY CHINNU, Bengaluru (IN); VIVEKANANDH NARAYANASAMY RAJAGOPALAN, Bangalore (IN); RAMJI RAMAGOPALAN, Bengaluru (IN)

(21) Appl. No.: 19/043,681

(22) Filed: Feb. 3, 2025

(51) Int. Cl. G06F 11/07; G06F 9/48; G06F 9/50

(52) U.S. Cl. CPC G06F 11/0793; G06F 9/4856; G06F 9/5005; G06F 2209/503

(57) ABSTRACT

Methods and systems for managing operation of a deployment are disclosed. The operation may be managed by using a proactive approach to perform a disaster recovery of the deployment. The proactive approach may include (i) obtaining information about a set of conditions to which the deployment may likely be exposed, (ii) determining whether and/or for how long the deployment may be unable to provide computer implemented services, and/or (iii) evaluating potential recovery sites based on available resources. The potential recovery sites may be ranked according to at least one quality of the available resources. A potential recovery site may be selected from the ranking. An infrastructure of the potential recovery site may be provisioned. Finally, the potential recovery site may continue to provide the computer implemented services.

### FIELD

Embodiments disclosed herein relate generally to managing operation of a deployment. More particularly, embodiments disclosed herein relate to selecting a potential recovery site to continue a provision of computer implemented services.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show interaction diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The operation may be managed by using a proactive approach to perform a disaster recovery of the deployment. The proactive approach may include (i) obtaining information about a set of conditions to which the deployment may likely be exposed, (ii) determining whether and/or for how long the deployment may be unable to provide computer implemented services, and (iii) evaluating potential recovery sites based on available resources of each of the potential recover sites that can be used to continue the provision of the computer implemented services.

Once the potential recovery sites have been evaluated, each of the potential recovery sites may be ranked. The ranking may be based on a score that has been computed by an objective function. The objective function may ingest at least one attribute of a potential recovery site including, for example, (i) a first at least one measure of a resource requirement, (ii) a second at least one measure of an available resource (e.g., hardware, software, etc.), (iii) a cost factor for provisioning the potential recovery site, (iv) a first risk measure that accounts for a likelihood at least one potential disaster in a geographic location of the potential recovery site, (v) a second risk measure that accounts for security protocols, etc.

From the ranking, the potential recovery site with a high ranking and/or sufficient ranking may be selected. Once the potential recovery site has been selected, a provisioning of an infrastructure of the potential recovery site may be performed. Upon the provisioning, the potential recovery site may continue to provide the computer implemented services.

In an embodiment, a method for managing operation of a deployment is disclosed. The method may include: (i) obtaining information regarding conditions to which the deployment is likely to be exposed, (ii) inferring, based on the conditions: (a) a likelihood of the deployment being unable to provide desired computer implemented services, and (b) a likely time at which the deployment will be unable to provide the desired computer implemented services, (iii) evaluating potential recovery sites for the deployment based on: (a) resource requirements for the desired computer implemented services, (b) available resources of the potential recovery sites, (c) a current time, and (d) the likely time to obtain a ranking of the potential recovery sites, (iv) selecting, based on the ranking, one of the potential recovery sites, and (v) performing a proactive disaster recovery for the deployment to facilitate continued provisioning of the desired computer implemented services regardless of a state of operation of the deployment.

The one of the potential recovery sites, after performing the proactive disaster recovery, may continue the provisioning of the desired computer implemented services when the deployment is unable to provide the desired computer implemented services.

Evaluating the potential recovery sites may include (i) obtaining, for each of the potential recovery sites, a quantification using an objective function, and (ii) using the quantifications for the potential recovery sites to obtain the ranking.

The potential recovery sites may be further evaluated based on estimated times for reconfiguring the respective potential recovery sites to provide the desired computer implemented services.

The resource requirements may include (a) processing cycles, (b) memory space, (c) storage space, and/or (d) communication bandwidth.

The resource requirements may include special purpose hardware device processing bandwidth.

The special purpose hardware device processing bandwidth may be provided by graphics processing units of the potential recovery sites.

Performing the proactive disaster recovery may include (i) reconfiguring the one of the potential recovery sites to provide the desired computer implemented services prior to the likely time and (ii) handing off responsibility for the desired computer implemented services to the one of the reconfigured one of the potential recovery sites prior to the likely time.

Performing the proactive disaster recovery may, prior to the reconfiguring the one of the potential recovery sites, further include performing comprehensive data protection strategies beyond periodic data backups to minimize data loss.

Performing the proactive disaster recovery may, prior to handing off the responsibility, further include (i) confirming, using an additional inferring of the likelihood of the deployment being unable to provide desired computer implemented services, that the deployment is still likely to be unable to provide the desired computer implemented services, and (ii) initiating the handing off in response to the confirming.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

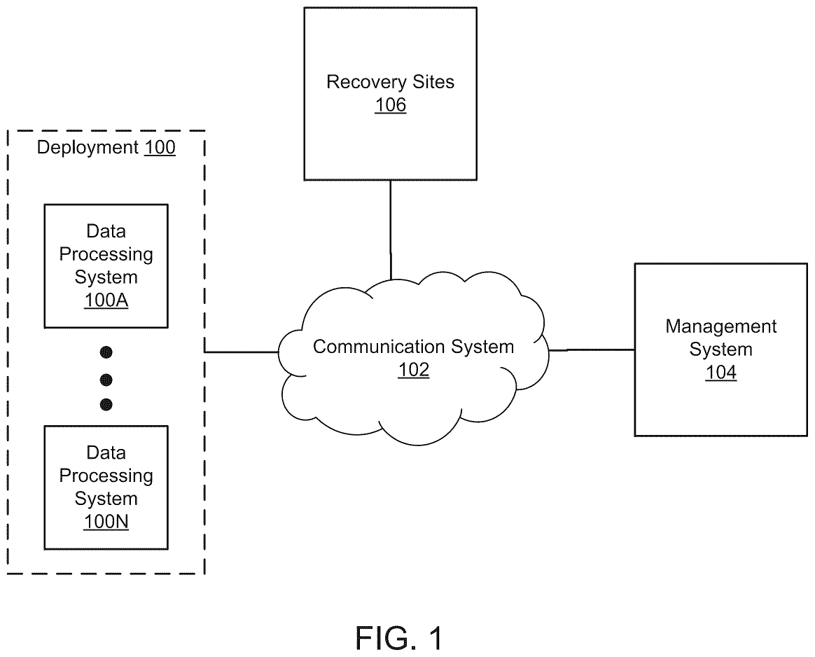

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, an operation may be performed using hardware, software, etc. configured with at least one data processing system of a deployment. At the site of the deployment, a natural disaster may take place.

Before and/or during the natural disaster at the site, a disaster recovery plan may be activated. The disaster recovery plan may include transmitting configuration data, software, etc. to a potential recovery site (e.g., a second deployment) for the continuation of the computer implemented services.

However, the configuration data, the software, hardware, etc. of the second deployment may be insufficient to continue provision of the computer implemented services. Therefore, the computer implemented service may be significantly impacted.

In general, embodiments disclosed here relate to systems and methods for managing operation of a deployment. The operation may be managed by performing a proactive disaster recovery plan if the deployment may be exposed to a set of conditions that can impact a provision of computer implemented services.

To perform the proactive recovery plan, first, information may be obtained that described the set of conditions. The information may be obtained by from (i) a weather monitoring system, (ii) an emergency alert system, (iii) satellite and/or sensor data, (iv) a communication from local authorities, etc. The set of conditions may include (i) at least one environmental condition (e.g., an earthquake, a wildfire, a tsunami, etc.), (ii) at least one utility condition (e.g., a power outage, a network failure, a hardware failure, etc.), (iii) at least one security condition (e.g., a cybersecurity risk, a data integrity risk, etc.), etc.

Because of the information of the set of the conditions, a likelihood and/or a period of time that the deployment is not able to provide the computer implemented services may be inferred. The likelihood and/or the period of the time may be inferred by assessing the set of the conditions and/or the impact.

Assessing the set of the conditions and/or the impact may include (i) measuring a scope and/or an intensity of a disaster that affects the deployment, (ii) measuring an extent of damage to a utility (e.g., a data center, a power line, network equipment, etc.) on which the deployment depends, etc.

Further, the likelihood and/or the period of the time may be inferred by estimating downtime of the deployment. Estimating the downtime may include (i) assessing a recovery time objective (e.g., a target duration within which the computer implemented services must be restored after the disaster), (ii) assessing the recovery point objective (e.g., a maximum acceptable amount of data loss; the data loss may be measured in time), (iii) receiving a timeline for at least one recovery effort and/or at least one restoration of at least one regional service from the local authorities, etc.

Next, potential recovery sites for the deployment may be evaluated. The potential recovery sites may include a potential recovery site (e.g., a second deployment) at which computer implemented services may be performed. The potential recovery sites may be evaluated based on (i) resource requirements for the computer implemented services, (ii) available resources of the potential recovery sites, (iii) a current time, (iv) a likely time to obtain a ranking of the potential recovery sites, etc.

The potential recovery sites may be evaluated by (i) identifying resources needed to perform the computer implemented services (e.g., a power requirement, a storage capacity, a network bandwidth, at least one software dependency, etc.), (ii) evaluating the resources available at least one of the potential recovery sites (e.g., hardware, software, network capabilities, etc.), (iii) noting the current time to determine an immediacy of at least one disaster recovery need, (iv) estimating a time required to collect and/or deploy configuration data, software, etc., to the at least one potential recovery site, etc.

The potential recovery site (e.g., the second deployment) may be selected based on a ranking of the potential recovery sites. The potential recovery site (e.g., the second deployment) may be selected by identifying the potential recovery site (e.g., the second deployment) on a list of ranked potential recovery sites and choosing the potential recovery site (e.g., the second deployment) with a high ranking and/or sufficient ranking. A quantification generated from an objective function may be used to generate at least one score which may be used to generate at least one ranking. The objective function may ingest (i) a first at least one measure of a resource requirement, (ii) a second at least one measure of an available resource (e.g., hardware, software, etc.), (iii) a cost factor for provisioning the potential recovery site, (iv) a first risk measure that accounts for a likelihood at least one potential disaster in a geographic location of the potential recovery site, (v) a second risk measure that accounts for security protocols, etc.

For each of the potential recovery sites on the list, the potential recovery site (e.g., the second deployment) may be ranked according to evaluation criteria. The evaluation criteria may include (i) resource matching (e.g., comparing resource requirements of the computer implemented services with available resource requirements of a potential recovery site), (ii) provisioning time (e.g., a time needed to provision to the potential recovery site (e.g., the second deployment) with configuration data, software, etc., to perform the computer implemented services), (iii) reliability and/or redundancy (e.g., an assessment of the resources to provide for continuous provision of the computer implemented services), (iv) risk (e.g., an assessment of a likelihood of a natural disaster, a breakdown of at least one utility, a breach of the at least one security condition, etc.), etc.

Finally, once the potential recovery site (e.g., the second deployment) has been selected, an infrastructure of the potential recovery site (e.g., the second deployment) may be provisioned to ensure performance of the computer implemented services. The infrastructure may be provisioned by (i) setting up at least one storage system, at least one network resource, at least one server, etc. at the potential recovery site, (ii) ensuring a latest data backup has been performed at the deployment and migrating data of the data backup to the potential recovery site, (iii) deploying at least one application and/or at least one service for performance of the computer implemented services, (iv) performing at least one configuration (e.g., at least one security setting, at least one network configuration, at least one application setting, etc.) at the potential recovery site, (v) redirecting incoming traffic from the deployment to the potential recovery site (e.g., the second deployment) using, for example, at least one change to a domain name system (DNS), a network traffic control tool, etc.

To provide the above noted functionality, the system may include deployment 100, management system 104, and recovery sites 106. Each of these components is discussed below.

Deployment 100 may include any number of data processing system 100A-100N and may include (i) hardware, (ii) software, (iii) network components, etc. The hardware, the software, the network components, etc. may be used to perform computer implemented services. The hardware may include (i) servers (e.g., for running applications, databases, services, etc.), (ii) storage devices (e.g., hard drives, solid-state drives, network-attached storage (NAS), etc.), (iii) power supply systems (e.g., uninterruptible power supplies (UPS), backup generators, etc.), (iv) data centers, etc. The software may include operating systems, (i) virtualization software (e.g. for virtualized operating systems, services, etc.), (ii) backup and recovery software, (iii) database management software (e.g., structured query language (SQL) server, Oracle, etc.), (iv) monitoring tools (e.g., for tracking system performance), etc. The network components may include (i) load balancers (e.g., for distributing network and/or application traffic across multiple servers, (ii) domain name system (DNS) servers, (iii) content delivery networks, etc.

If a set of conditions may impact performance of the computer implemented service by the deployment, a disaster recovery plan may be performed. The set of conditions may include (i) at least one environmental condition (e.g., an earthquake, a wildfire, a tsunami, etc.), (ii) at least one in utility condition (e.g., a power outage, a network failure, a hardware failure, etc.), (iii) at least one security condition (e.g., a cybersecurity risk, a data integrity risk, etc.), etc. The disaster recovery plan may include inferring, based on the set of the conditions, a likelihood and/or a period of time that deployment 100 is not able to provide computer implemented services.

Management system 104 may infer the likelihood and/or the period of the time that deployment 100 is not able to provide the computer implemented services. by assessing the set of the conditions and/or an impact by the set of the conditions. Further, management system 104 may infer the likelihood and/or the period of the time by estimating downtime of the deployment.

Management system 104 may evaluate potential recovery sites by (i) identifying resources needed to perform the computer implemented services (e.g., a power requirement, a storage capacity, a network bandwidth, at least one software dependency, etc.), (ii) evaluating the resources available at least one of the potential recovery sites (e.g., the hardware, the software, the network components, etc.), (iii) noting the current time to determine an immediacy of at least one disaster recovery need, (iv) estimating a time required to collect and/or deploy configuration data, software, etc., to the at least one potential recovery site, etc.

Based on the evaluation, management system 104 may select a potential recovery site of the potential recovery sites. Management system 104 may select the potential recovery site by identifying the potential recovery site on a list of ranked potential recovery sites and choosing the potential recovery site with a high ranking and/or sufficient ranking. Management system 104 may generate a quantification from an objective function. At least one ranking may be based on at least one quantification. The objective function may ingest (i) a first at least one measure of a resource requirement, (ii) a second at least one measure of an available resource (e.g., hardware, software, etc.), (iii) a cost factor for provisioning the potential recovery site, (iv) a first risk measure that accounts for a likelihood at least one potential disaster in a geographic location of the potential recovery site, (v) a second risk measure that accounts for security protocols, etc.

Management system 104 may evaluate the potential recovery sites based on (i) resource matching (e.g., comparing resource requirements of the computer implemented services with available resource requirements of a potential recovery site), (ii) provisioning time (e.g., a time needed to provision to the potential recovery site (e.g., a second deployment) with configuration data, software, etc., to perform the computer implemented services), (iii) reliability and/or redundancy (e.g., an assessment of the resources to provide for continuous provision of the computer implemented services), (iv) risk (e.g., an assessment of a likelihood of a natural disaster, a breakdown of at least one utility component, a breach of the at least one security condition, etc.), etc.

Finally, management system 104 may provision an infrastructure of the potential recovery site (e.g., the second deployment) to ensure performance of the computer implemented services. Management system 104 may provision an infrastructure by (i) setting up at least one storage system, at least one network resource, at least one server, etc. at the potential recovery site, (ii) ensuring a latest data backup has been performed at the deployment and/or migrating data of the data backup to the potential recovery site, (iii) deploying at least one application and/or at least one service for performance of the computer implemented services, (iv) performing at least one configuration (e.g., at least one security setting, at least one network configuration, at least one application setting, etc.) at the potential recovery site, (v) redirecting incoming traffic from the deployment to the potential recovery site (e.g., the second deployment) using, for example, at least one change to a domain name system (DNS), a network traffic control tool, etc.

Recovery sites 106 may include the potential recovery sites of deployment 100. Recovery sites 106 may include hot sites (e.g., fully equipped with the hardware, the software, the network capabilities, etc. and therefore include similar resources as deployment 100), warm sites (e.g., partially equipped with the hardware, the software, the network capabilities, etc. compared to deployment 100 and therefore may require additional provisioning), and/or cold sites (e.g., minimally equipped with the hardware, the software, the network capabilities, etc. compared to deployment 100 and therefore may require significant provisioning to provide computer implemented services similar to deployment 100). Recovery sites 106 may include characteristics such as geographic separation (e.g., having a location far enough from deployment 100 to be unaffected by at least one of the conditions of the set of the conditions), redundancy (e.g., being equipped with sufficient resource to ensure continuous provision of the computer implemented services), security (e.g., having security measures enacted to protect data and services during and after activating the disaster recovery plan), etc.

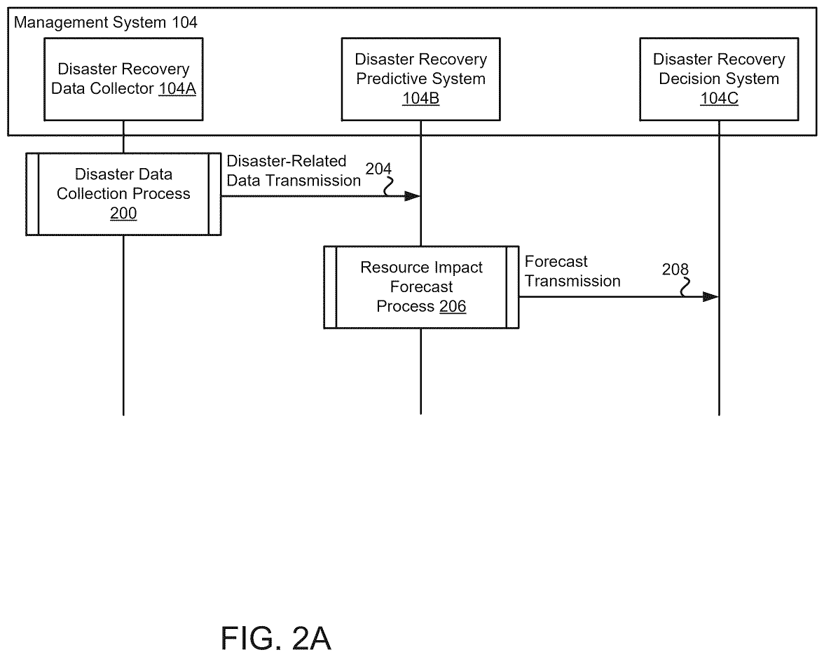

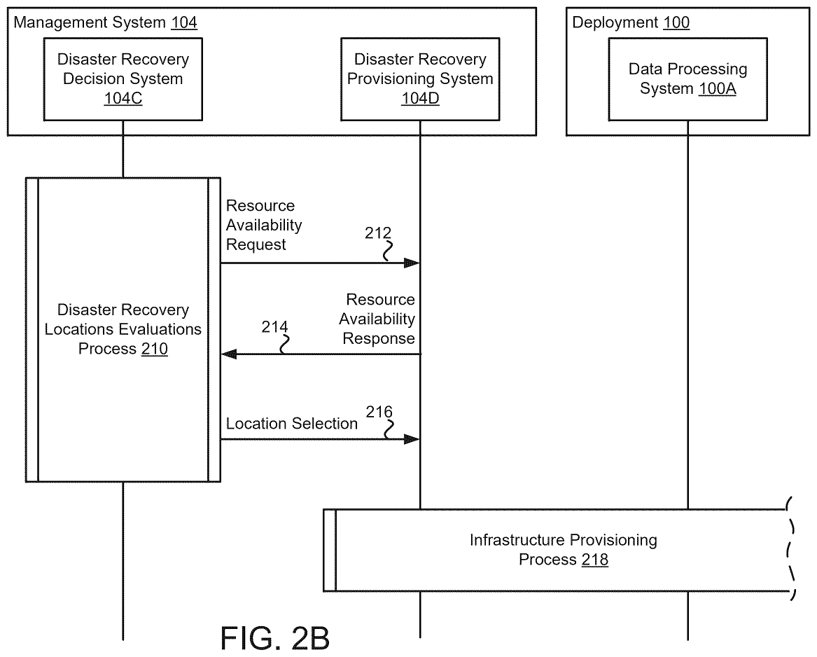

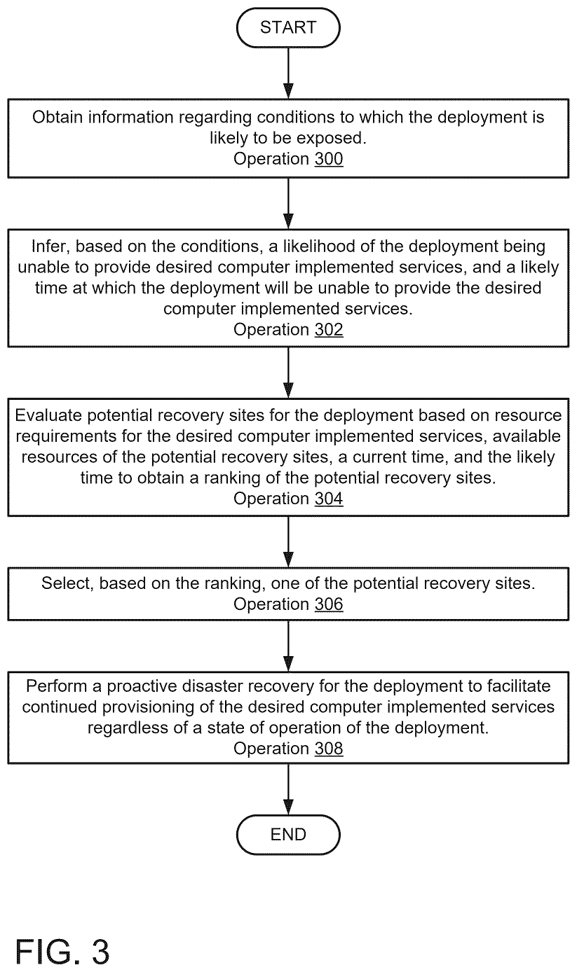

While providing their functionality, any of deployment 100, management system 104, and/or recovery sites 106 may perform all, or a portion, of the flows and methods shown in FIGS. 2A-3.

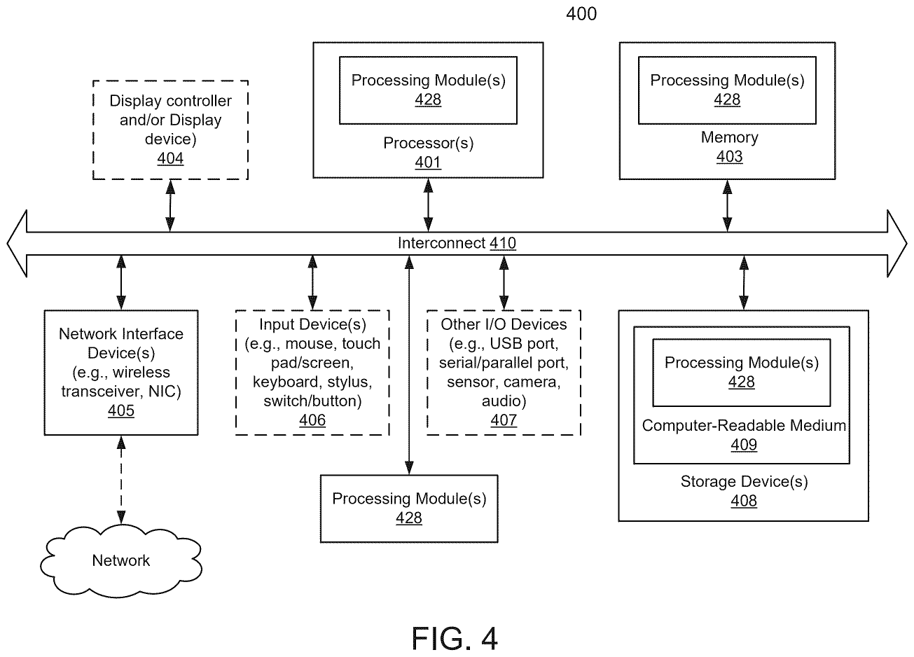

Any of (and/or components thereof) deployment 100, management system 104, and recovery sites 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2B. These interactions diagrams may illustrate how data may be obtained and used within the system of FIGS. 2A-2B.

In the interaction diagrams, processes performed by and interactions between components of a system in accordance with an embodiment are shown. In the diagrams, components of the system are illustrated using a first set of shapes (e.g., 104A, 104B, etc.), located towards the top of each figure. Lines descend from these shapes. Processes performed by the components of the system are illustrated using a second set of shapes (e.g., 200, 206, etc.) superimposed over these lines. Interactions (e.g., communication, data transmissions, etc.) between the components of the system are illustrated using a third set of shapes (e.g., 204, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in forecasting an impact of a disaster on a deployment (e.g., 100).

To forecast the impact, disaster data collection process 200 may be performed. During disaster data collection process 200, disaster recovery data collector 104A may obtain disaster-related data. The disaster related data may include information about (i) at least one environmental condition (e.g., an earthquake, a wildfire, a tsunami, etc.), (ii) at least one in utility condition (e.g., a power outage, a network failure, a hardware failure, etc.), (iii) at least one security condition (e.g., a cybersecurity risk, a data integrity risk, etc.), etc.

Disaster recovery data collector 104A may obtain the disaster-related data by monitoring (i) a weather monitoring system, (ii) an emergency alert system, (iii) satellite and/or sensor data, (iv) a communication from local authorities, etc. The information of the disaster-related data may affect a provision of computer implemented services by the deployment (e.g., 100).

Once the disaster-related data has been obtained, disaster recovery data collector 104A may transmit (e.g., 204) the disaster-related data to disaster recovery predictive system 104B. Disaster recovery data collector 104A may transmit (e.g., 204) the disaster-related data using, for example, a communication protocol of management system 104. The communication protocol may enable transmission of the disaster-related data using a message queue, data stream, shared memory, etc.

The disaster-related data may be received by disaster recovery predictive system 104B. Once received, resource impact forecast process 206 may be performed. During resource impact forecast process 206, disaster recovery predictive system 104B may assess an impact on the deployment (e.g., 100) by at least one condition (e.g., environmental-related, utility-related, security-related, etc.) of the disaster-related data.

The impact may be assessed by inferring, by disaster recovery predictive system 104B, a likelihood and/or a period of time that the deployment (e.g., 100) is not able to provide computer implemented services. The assessment may include (i) measuring a scope and/or an intensity of a disaster that affects the deployment (e.g., 100) to provide the computer implemented services, (ii) measuring an extent of damage to a utility (e.g., a data center, a power line, network equipment, etc.) on which the deployment (e.g., 100) depends, etc.

Further, the likelihood and/or the period of the time may be inferred, by disaster recovery predictive system 104B, by estimating downtime of the deployment (e.g., 100). Estimating the downtime may include (i) assessing a recovery time objective (e.g., a target duration within which computer implemented services must be restored after the disaster), (ii) assessing the recovery point objective (e.g., a maximum acceptable amount of data loss; the data loss may be measured in time), (iii) receiving a timeline for at least one recovery effort and at least one restoration of at least one service from local authorities, etc.

The likelihood and/or the period of the time may be used to generate a forecast. The forecast may be generated by (i) performing a statistical analysis using the extent of the damage, the measure of the intensity of the disaster, etc., to generate a likelihood estimation, (ii) performing, using the recovery time objective, the recovery point objective, etc., downtime modeling to estimate a duration of the downtime for the disaster, and/or (iii) combining the likelihood estimate and/or an least one output of the downtime model to generate the forecast for a disruption of the computer implemented services.

Once the forecast has been obtained, disaster recovery predictive system 104B may transmit (e.g., 208) the forecast to disaster recovery decision system 104C. Disaster recovery predictive system 104B may transmit (e.g., 208) the forecast using, for example, a communication protocol of management system 104. The communication protocol may enable transmission of the disaster-related data using a message queue, data stream, shared memory, etc.

Thus, via the interaction illustrated in FIG. 2A, a system in accordance with an embodiment may forecast the impact of the disaster on the deployment (e.g., 100). Consequently, a deployment (e.g., 100) may be more likely to be able to provide desired computer implemented services by using disaster-related data of a disaster in proximity to the deployment (e.g., 100) to generate the forecast of the disruption to the provision of the computer implemented services.

Turning to FIG. 2B, a second interaction diagram in accordance with an embodiment is shown. The second diagram may illustrate data used in and data processing performed in provisioning an infrastructure of a second deployment to provide computer implemented services.

To provision the infrastructure, disaster recovery location evaluations process 210 may be performed. During disaster recovery location evaluations process 210, a location of a potential recovery site (e.g., the second deployment) may be determined. The potential recovery site (e.g., the second deployment) may be chosen to continue the provision of the computer implemented services. The potential recovery site (e.g., the second deployment) may include a second deployment. The provision may need to be continued at the potential recovery site (e.g., the second deployment) due to a disruption in the provision from a deployment (e.g., 100) by a disaster. The disaster may include (i) at least one environmental condition (e.g., an earthquake, a wildfire, a tsunami, etc.), (ii) at least one in utility condition (e.g., a power outage, a network failure, a hardware failure, etc.), (iii) at least one security condition (e.g., a cybersecurity risk, a data integrity risk, etc.), etc.

To determine the potential recovery site, potential recovery sites may be evaluated. The potential recovery sites may be evaluated for a capability to continue the provision of the computer implemented services. The potential recovery sites may be evaluated based on (i) resource requirements of the computer implemented services, (ii) available resources of the potential recovery sites, (iii) a current time, (iv) a likely time to obtain a ranking of the potential recovery sites.

To perform the evaluation, disaster recovery decision system 104C may transmit (e.g., 212) a request to disaster recovery provisioning system 104D. The request may include, for each of the potential recovery sites, resource availability that identifies (i) a geographic location, (ii) network capability requirements (bandwidth, latency, etc.), (iii) current resource utilization, (iv) security protocols, (v) present hardware and/or software, (iv) environmental risks at the geographic location, etc. Disaster recovery decision system 104C may transmit (e.g., 212) the request using, for example, a communication protocol of management system 104. The communication protocol may enable transmission of the request using a message queue, data stream, shared memory, etc.

Disaster recovery provisioning system 104D may receive (e.g., 212) the request. Upon receiving the request, disaster recovery provisioning system 104D may obtain the resource availability for each of the potential recovery sites. The resource availability may be obtained by using (i) application programming interface calls, (ii) at least one site survey, (iii) at least one monitoring tool, (iv) at least one third-party report from a consultant, vendor, etc. who has certified at least one potential recovery site, etc. to gather the resource availability of the at least one potential recovery site.

One the resource availability has been obtained, disaster recovery provisioning system 104D may transmit (e.g., 214) the resource availability to disaster recovery decision system 104C. Disaster recovery provisioning system 104D may transmit (e.g., 214) the resource availability using, for example, the communication protocol of management system 104. The communication protocol may enable transmission of the resource availability using a message queue, data stream, shared memory, etc.

Once the resource availability has been received, disaster recovery decision system 104C may evaluate the potential recovery sites. The potential recovery sites may be evaluated by (i) identifying resources needed to perform the computer implemented services (e.g., a power requirement, a storage capacity, a network bandwidth, at least one software dependency, etc.), (ii) evaluate the resources available at least one of the potential recovery sites (e.g., hardware, software, network capabilities, etc.), (iii) noting the current time to determine an immediacy of at least one disaster recovery need, (iv) estimate a time required to collect and deploy configuration data, software, etc., to the at least one potential recovery site, etc.

A potential recovery site (e.g., the second deployment) may be selected based on a ranking of the potential recovery sites. The potential recovery site (e.g., the second deployment) may be selected by identifying the potential recovery site on a list of ranked potential recovery sites and choosing the potential recovery site (e.g., the second deployment) with a high ranking and/or sufficient ranking. A quantification generated from an objective function may be used to generate at least one score which may be used to generate at least one ranking. The objective function may ingest (i) a first at least one measure of a resource requirement, (ii) a second at least one measure of an available resource (e.g., hardware, software, etc.), (iii) a cost factor for provisioning the potential recovery site, (iv) a first risk measure that accounts for a likelihood at least one potential disaster in a geographic location of the potential recovery site, (v) a second risk measure that accounts for security protocols, etc.

For each of the potential recovery sites on the list, the potential recovery site (e.g., the second deployment) may be ranked according to evaluation criteria. The evaluation criteria may include (i) resource matching (e.g., comparing resource requirements of the computer implemented services with available resource requirements of a potential recovery site), (ii) provisioning time (e.g., a time needed to provision to the potential recovery site (e.g., the second deployment) with configuration data, software, etc., to perform the computer implemented services), (iii) reliability and/or redundancy (e.g., an assessment of the resources to provide for continuous provision of the computer implemented services), (iv) risk (e.g., an assessment of a likelihood of a natural disaster, a breakdown of at least one utility, a breach of the at least one security condition, etc.), etc.

Location data of the potential recovery site (e.g., the second deployment) with a high ranking and/or sufficient ranking may be transmitted (e.g., 216) from disaster recovery decision system 104C to disaster recovery provisioning system 104D. Disaster recovery decision system 104C may transmit (e.g., 216) the location data using, for example, the communication protocol of management system 104. The communication protocol may enable transmission of the resource availability using a message queue, data stream, shared memory, etc.

On receiving the location data of the potential recovery site (e.g., the second deployment), infrastructure provisioning process 218 may be performed. During infrastructure provisioning process 218, an infrastructure of the potential recovery site (e.g., the second deployment) may be provisioned by disaster recovery provisioning system. The infrastructure may be provisioned by (i) setting up at least one storage system, at least one network resource, at least one server, etc. at the potential recovery site, (ii) ensuring a latest data backup has been performed at the deployment (e.g., 100) and/or migrating data of the data backup to the potential recovery site, (iii) deploying at least one application and/or at least one service for performance of the computer implemented services, (iv) performing at least one configuration (e.g., at least one security setting, at least one network configuration, at least one application setting, etc.) at the potential recovery site, (v) redirecting incoming traffic from the deployment (e.g., 100) to the potential recovery site (e.g., the second deployment) using, for example, at least one change to a domain name system (DNS), a network traffic control tool, etc.

Further, disaster recovery provisioning system 104D may perform at least one performance test of the software, the hardware, the network capabilities, etc. to ensure that provisioning of the computer implemented services is functional at the potential recovery site. The performance tests used by disaster recovery provisioning system 104D may include load testing (e.g., an evaluation of how the second deployment behaves under peak load conditions), stress testing (e.g., an evaluation of performance limits of the second deployment), spike testing (e.g., an evaluation of how the second deployment responds to a sudden and quick increase in the load), soak testing (e.g., an evaluation of the performance of the second deployment over an extended period of time), volume testing (e.g., an evaluation of the performance of the second deployment using a large amount of data), etc. Also, monitoring tools may be used by disaster recovery provisioning system 104D to ensure continuous provision of the computer implemented services. The monitoring tools may include (i) real-time performance monitoring, (ii) system health checks, (iii) log collection and analysis, (iv) security monitoring, etc.

Thus, via the interaction illustrated in FIG. 2B, a system in accordance with an embodiment may provision the infrastructure of the second deployment to provide computer implemented services. Consequently, the second deployment may be more likely to be able to provide desired computer implemented services by continuing the provision of the computer implemented services.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the operation of the deployment in accordance with an embodiment is shown. The method may be performed, for example, by any of the components of the system of FIG. 1, and/or other components not shown therein.

At operation 300, information may be obtained regarding conditions to which the deployment (e.g., 100) is likely exposed. The information may be obtained by receiving at least one notification from (i) a weather monitoring system, (ii) an emergency alert system, (iii) satellite and/or sensor data, (iv) a communication from local authorities, etc. The information may include a set of conditions, for example, (i) at least one environmental condition (e.g., an earthquake, a wildfire, a tsunami, etc.), (ii) at least one utility condition (e.g., a power outage, a network failure, a hardware failure, etc.), (iii) at least one security condition (e.g., a cybersecurity risk, a data integrity risk, etc.), etc.

At operation 302, a likelihood of the deployment (e.g., 100) being unable to provide desired computer implemented services and/or a likely time at which the deployment (e.g., 100) will be unable to provide the desired computer implemented services may be inferred, based on the conditions. The likelihood and/or the likely time may be inferred by assessing the set of the conditions and/or the impact. Assessing the set of the conditions and/or the impact may include (i) measuring a scope and/or an intensity of a disaster that affects the deployment (e.g., 100), (ii) measuring an extent of damage to a utility (e.g., a data center, a power line, network equipment, etc.) on which the deployment (e.g., 100) depends, etc.

Further, the likelihood and/or the period of the time may be inferred by estimating downtime of the deployment (e.g., 100). Estimating the downtime may include (i) assessing a recovery time objective (e.g., a target duration within which desired computer implemented services must be restored after the disaster), (ii) assessing the recovery point objective (e.g., a maximum acceptable amount of data loss; the data loss may be measured in time), (iii) receiving a timeline for at least one recovery effort and/or at least one restoration of at least one service from the local authorities, etc.

At operation 304, potential recovery sites may be evaluated based on resource requirements for the desired computer implemented services, available resources of the potential recovery sites, a current time, and/or the likely time to obtain a ranking of the potential recovery sites. The potential recovery sites may be evaluated by (i) obtaining, for each of the potential recovery sites, a quantification using an objective function and (ii) using the quantifications for the potential recovery sites to obtain the ranking.

Obtaining the quantification may include (i) ingesting into the objective function (a) a first at least one measure of one resource requirement, (b) a second at least one measure of an available resource (e.g., hardware, software, etc.), (c) a cost factor for provisioning the potential recovery site, (d) a risk measure that accounts for a likelihood at least one potential disaster in a geographic location of the potential recovery site, (e) a second risk measure that accounts for security protocols, etc. and (ii) solving the objective function to generate the quantification. Using the quantification may include computing, for each potential recovery site of the potential recovery sites, a score (e.g., a higher score indicating a better equipped potential recovery site for provision of the desired computer implemented services) may be used to generate at least one ranking of each potential recovery site.

At operation 306, one (e.g., the potential recovery site) of the potential recovery sites may be selected based on the ranking. The potential recovery site (e.g., the second deployment) may be selected by assigning, by an administrator, a monitoring tool, etc., the potential recovery site (e.g., the second deployment) as a second deployment for the provision of the desired computer implemented services.

At operation 308 a proactive disaster recovery may be performed for the deployment (e.g., 100) to facilitate continued provisioning of the desired computer implemented services regardless of a state of operation of the deployment (e.g., 100). The proactive disaster recovery may be performed by (i) reconfiguring the one (e.g., the potential recovery site) of the potential recovery sites to provide the desired computer implemented services prior to the likely time and (ii) handing off responsibility for the desired computer implemented services to the one of the reconfigured one of the potential recovery sites prior to the likely time.

The potential recovery site (e.g., the second deployment) may be reconfigured by (i) setting up at least one storage system, at least one network resource, at least one server, etc. at the potential recovery site, (ii) ensuring a latest data backup has been performed at the deployment (e.g., 100) and/or migrating data of the data backup to the potential recovery site, (iii) deploying at least one application and/or at least one service for performance of the computer implemented services, (iv) performing at least one configuration (e.g., at least one security setting, at least one network configuration, at least one application setting, etc.) at the potential recovery site, (v) redirecting incoming traffic from the deployment (e.g., 100) to the potential recovery site (e.g., the second deployment) using, for example, at least one change to a domain name system (DNS), a network traffic control tool, etc.

The responsibility for the desired computer implemented services may be handed off by transmitting at least one instruction for the provision of the desired computer implemented services. Further, at least one performance test of the software, the hardware, network capabilities, etc. may be performed to ensure provisioning of the desired computer implemented services is functional at the potential recovery site. Also, at least one monitoring tool may be used to ensure continued provision of the desired computer implemented services.

The proactive disaster recovery may be further performed, prior to the reconfiguring the one of the potential recovery sites, by performing comprehensive data protection strategies beyond periodic data backups to minimize data loss. The comprehensive data protection strategies may be performed by utilizing (i) data synchronization between the deployment (e.g., 100) and/or the potential recovery site, (ii) cloud storage services, (iii) distributed file systems, etc. to ensure data is accessible at the potential recovery site (e.g., the second deployment) of the potential recovery sites.

The proactive disaster recovery may be further performed, prior to handing off the responsibility, (i) confirming, using an additional inferring of the likelihood of the deployment (e.g., 100) being unable to provide desired computer implemented services, that the deployment (e.g., 100) is still likely to be unable to provide the desired computer implemented services; and (ii) initiating the handing off in response to the confirming.

The inability of the deployment (e.g., 100) to provide the desired computer implemented services may be confirmed by receiving a second at least one notification from (i) the weather monitoring system, (ii) the emergency alert system, (iii) the satellite and/or the sensor data, (iv) the communication from the local authorities, etc. If the second at least one notification is similar to the at least one notification, then the inability of the deployment (e.g., 100) to provide the desired computer implemented services may be confirmed. The handing of may be initiated by performing the provisioning of the infrastructure of the potential recovery site.

The method may end following operation 308.

Thus, via the method shown in FIG. 3, embodiments herein may likely improve a likelihood of managing the operation of the deployment (e.g., 100). By improving the likelihood of managing the operation of the deployment (e.g., 100), the data processing system may be more likely to provide desirable computer implemented services by, for example, making a determination of the likelihood and/or the period of the time that the deployment (e.g., 100) may be unable to provide the desired computer implemented services, choosing the potential recovery site (e.g., the second deployment) based on a capability of the potential recovery site (e.g., the second deployment) to continue the provision of the desired computer implemented services for disaster recovery, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
obtaining information regarding conditions to which the deployment is likely to be exposed;
inferring, based on the conditions:
a likelihood of the deployment being unable to provide desired computer implemented services, and
a likely time at which the deployment will be unable to provide the desired computer implemented services;
evaluating potential recovery sites for the deployment based on:
resource requirements for the desired computer implemented services,
available resources of the potential recovery sites,
a current time, and
the likely time to obtain a ranking of the potential recovery sites;
selecting, based on the ranking, one of the potential recovery sites; and
performing a proactive disaster recovery for the deployment to facilitate continued provisioning of the desired computer implemented services regardless of a state of operation of the deployment.

2. The method of claim 1, wherein the one of the potential recovery sites, after performing the proactive disaster recovery, continues the provisioning of the desired computer implemented services when the deployment is unable to provide the desired computer implemented services.

3. The method of claim 1, wherein evaluating the potential recovery sites comprises:
obtaining, for each of the potential recovery sites, a quantification using an objective function; and
using the quantifications for the potential recovery sites to obtain the ranking.

4. The method of claim 3, wherein the potential recovery sites are further evaluated based on estimated times for reconfiguring the respective potential recovery sites to provide the desired computer implemented services.

5. The method of claim 3, wherein the resource requirements comprise:
processing cycles,
memory space,
storage space, and
communication bandwidth.

6. The method of claim 5, wherein the resource requirements further comprise:
special purpose hardware device processing bandwidth.

7. The method of claim 6, wherein the special purpose hardware device processing bandwidth is provided by graphics processing units of the potential recovery sites.

8. The method of claim 1, wherein performing the proactive disaster recovery comprises:
reconfiguring the one of the potential recovery sites to provide the desired computer implemented services prior to the likely time; and
handing off responsibility for the desired computer implemented services to the one of the reconfigured one of the potential recovery sites prior to the likely time.

9. The method of claim 8, wherein performing the proactive disaster recovery further comprises:
prior to the reconfiguring the one of the potential recovery sites:
performing comprehensive data protection strategies beyond periodic data backups to minimize data loss.

10. The method of claim 8, wherein performing the proactive disaster recovery further comprises:
prior to handing off the responsibility:
confirming, using an additional inferring of the likelihood of the deployment being unable to provide desired computer implemented services, that the deployment is still likely to be unable to provide the desired computer implemented services; and
initiating the handing off in response to the confirming.

11. A non-transitory machine-readable medium having instructions stored therein, which when executed by a processor, cause the processor to perform operations for managing operation of a deployment, the operations comprising:
obtaining information regarding conditions to which the deployment is likely to be exposed;
inferring, based on the conditions:
a likelihood of the deployment being unable to provide desired computer implemented services, and
a likely time at which the deployment will be unable to provide the desired computer implemented services;
evaluating potential recovery sites for the deployment based on:
resource requirements for the desired computer implemented services,
available resources of the potential recovery sites,
a current time, and
the likely time to obtain a ranking of the potential recovery sites;
selecting, based on the ranking, one of the potential recovery sites; and
performing a proactive disaster recovery for the deployment to facilitate continued provisioning of the desired computer implemented services regardless of a state of operation of the deployment.

12. The non-transitory machine-readable medium of claim 11, wherein the one of the potential recovery sites, after performing the proactive disaster recovery, continues the provisioning of the desired computer implemented services when the deployment is unable to provide the desired computer implemented services.

13. The non-transitory machine-readable medium of claim 11, wherein evaluating the potential recovery sites comprises:
obtaining, for each of the potential recovery sites, a quantification using an objective function; and
using the quantifications for the potential recovery sites to obtain the ranking.

14. The non-transitory machine-readable medium of claim 13, wherein the potential recovery sites are further evaluated based on estimated times for reconfiguring the respective potential recovery sites to provide the desired computer implemented services.

15. The non-transitory machine-readable medium of claim 13, wherein the resource requirements comprise:
processing cycles,
memory space,
storage space, and
communication bandwidth.

16. A data processing system, comprising:
a processor; and
a memory coupled to the processor to store instructions, which when executed by the
processor, cause the processor to perform operations managing operation of a deployment, the operations comprising:
obtaining information regarding conditions to which the deployment is likely to be exposed;
inferring, based on the conditions:
a likelihood of the deployment being unable to provide desired computer implemented services, and
a likely time at which the deployment will be unable to provide the desired computer implemented services;
evaluating potential recovery sites for the deployment based on:
resource requirements for the desired computer implemented services, available resources of the potential recovery sites,
a current time, and
the likely time to obtain a ranking of the potential recovery sites;
selecting, based on the ranking, one of the potential recovery sites; and
performing a proactive disaster recovery for the deployment to facilitate continued provisioning of the desired computer implemented services regardless of a state of operation of the deployment.

17. The data processing system of claim 16, wherein the one of the potential recovery sites, after performing the proactive disaster recovery, continues the provisioning of the desired computer implemented services when the deployment is unable to provide the desired computer implemented services.

18. The data processing system of claim 16, wherein evaluating the potential recovery sites comprises:
obtaining, for each of the potential recovery sites, a quantification using an objective function; and
using the quantifications for the potential recovery sites to obtain the ranking.

19. The data processing system of claim 18, wherein the potential recovery sites are further evaluated based on estimated times for reconfiguring the respective potential recovery sites to provide the desired computer implemented services.

20. The data processing system of claim 18, wherein the resource requirements comprise:
processing cycles,
memory space,
storage space, and
communication bandwidth.
